(19) United States
(12) Patent Application Publication
(10) Pub. No.: US 2026/0227200 A1
(43) Pub. Date: Aug. 6, 2026

(54) METHOD AND DEVICE FOR CORRECTING A DIGITAL MAP

(71) Applicant: Robert Bosch GmbH, Stuttgart (DE)

(72) Inventors: Henning Lategahn, Pfinztal (DE); Jan Rohde, Dettingen Unter Teck (DE); Julius Ziegler, Karlsruhe (DE); Philipp Crocoll, Stutensee (DE)

(21) Appl. No.: 19/388,241

(22) Filed: Nov. 13, 2025

(30) Foreign Application Priority Data
Nov. 29, 2024 (DE) 10 2024 211 438.3

(51) Int. Cl. G01C 21/00; G06N 20/00

(52) U.S. Cl. CPC G01C 21/3859; G06N 20/00

(57) ABSTRACT

A method for correcting a digital map. The method includes: carrying out a calibration phase including: selecting a first map section of the digital map, checking the first map section for errors and correcting the errors found in the first map section in a first correction stage, checking the corrected first map section for errors and correcting the errors found in the corrected first map section in a further correction stage, repeating the further correction stage until fewer than a predetermined number of errors are found in at least two successive correction stages, as a result of which a first number of correction stages of the first map section from the calibration phase is ascertained, ascertaining a second number of needed correction stages for remaining map sections based on the first number of correction stages implemented in the calibration phase for the first map section.

### CROSS REFERENCE

The present application claims the benefit under 35 U.S.C. § 119 of Germany Patent Application No. DE 10 2024 211 438.3 filed on Nov. 29, 2024, which is expressly incorporated herein by reference in its entirety.

### FIELD

The related art in the field of error detection and correction of digital maps, in particular HD maps, includes a variety of approaches for reviewing and improving map quality.

A conventional method, as described in U.S. Patent Application No. US 2023/0137111 A1, describes establishing a frequency for reviewing map segments based on the frequency of errors and the time to the next encounter with the segment. This method includes a manual review of the segments, which improves map quality but requires a significant amount of manual effort.

An object of the present invention is to provide a method and a system for correcting digital maps, in particular HD maps, that enables efficient and precise determination of the error probability.

### SUMMARY

The present invention relates to a method for correcting a digital map. According to an example embodiment of the present invention, the method comprises the following steps: carrying out a calibration phase comprising the following steps:

selecting a first map section of the digital map, checking the first map section for errors and correcting the errors found in the first map section in a first correction stage, checking the corrected first map section for errors and correcting the errors found in the corrected first map section in a further correction stage, repeating the further correction stage until fewer than a predetermined number of errors, in particular no errors, are found in at least two successive correction stages, as a result of which a first number of correction stages of the first map section from the calibration phase is ascertained, ascertaining a second number of correction stages needed for remaining map sections based on the first number of correction stages implemented out in the calibration phase for the first map section, wherein the second number of needed correction stages is at least one correction stage less, preferably at least three correction stages less, than the first number of correction stages implemented in the calibration phase, wherein each one of the remaining map sections of the digital map is checked and corrected with the ascertained second number of correction stages.

A first map section refers to a defined portion of the digital map selected for the calibration phase. A digital map is a map representation stored in electronic form that may include geographic, structural or functional information. Errors are deviations from a defined target state or a given reference that can affect the accuracy or functionality of the digital map. Correction stages are individual, iterative steps for reviewing and eliminating errors in the map sections. Remaining map sections are the portions of the digital map that are checked and corrected after the calibration phase.

The method of the present invention uses the number of errors identified and eliminated in each correction stage to calculate a detection rate per correction stage. This detection rate describes the percentage of currently remaining errors that can be corrected in each stage. The detection rate per correction stage can be 90%, for instance; which means that 90% of the remaining errors are identified and corrected at each stage.

According to an example embodiment of the present invention, the method can also be used to determine the initial number of errors per unit of map length, for example per 100 km, in the initial map. Based on these two values—the detection rate and the initial error density—it is possible to calculate how many correction stages are needed to achieve a specific maximum error frequency, which can then be defined as a quality target for verification.

The following embodiment example of the method of the present invention illustrates the calculation: If the initial map has an error density of 1000 errors per 100 km and a detection rate of 90% is achieved for each correction stage, the quality target of a maximum of 5 errors per 100 km can be achieved by three correction stages, for example. After the first stage there are still 100 errors per 100 km, after the second step there are still 10 errors per 100 km, and after the third stage, the number of errors is reduced to 1 error per 100 km, thus exceeding the target.

This method significantly increases the efficiency of the verification process, because the number of correction steps required can be specifically defined to achieve the desired error frequency. This leads to optimized use of resources and an improved results in map verification for vehicle navigation.

An advantage of this method is that the correction stages are specifically tailored to the requirements of the map, which increases the efficiency of the review and at the same time improves map quality. Reducing the correction stages for the remaining map sections minimizes the review effort without compromising accuracy.

According to an example embodiment of the present invention, the calibration phase can advantageously be carried out separately for each type of map or specific map elements of the digital map to optimize the verification burden.

A type of map refers to different types of digital maps that are distinguished by their specific characteristics, such as urban areas or forested areas. The map elements are specific features or structures within the digital map.

This ensures that the review processes are tailored to the respective type of map or to specific map elements, which increases the accuracy and efficiency of the correction.

According to an example embodiment of the present invention, a correction stage can advantageously be implemented by a person or a manual reviewer, wherein the person compares the first map section with a reference map section with respect to at least one feature and manually corrects a deviation of the first map section from the reference map section in the first map section, in particular using a graphical user interface.

A manual reviewer is a person who checks map sections for errors and corrects them. A graphical user interface is a digital tool that allows the reviewer to visually analyze the map sections and make adjustments.

This ensures precise correction through the use of human expertise, in particular for complex map sections or specific types of errors that are difficult to detect automatically.

According to an example embodiment of the present invention, a correction stage can advantageously be implemented automatically by a AI model, wherein the AI model checks the first map section with respect to at least one feature and corrects an error of the first map section in the first map section.

The AI model is an algorithmic system that is developed using machine learning to automatically learn and execute specific tasks by analyzing data. The AI model is thereby trained to detect and classify errors in digital maps. It uses the results of previous correction stages as training data to identify patterns and typical errors in the map data. This learning process enables the AI model to carry out the reviews with increasing efficiency and accuracy. The AI model acts independently and can continuously improve its ability to predict and validate errors, which leads to the automation of the review process.

This results in high processing speed and makes it possible to efficiently analyze and correct large map sections.

In each individual correction stage, multiple manual reviewers can advantageously examine the respective map section of the digital map for errors using a graphical user interface or AI models to increase the accuracy of the review, wherein the error rate is estimated by applying a statistical method, preferably averaging, to the results of the different reviewers or AI models.

A statistical method is a mathematical technique for analyzing and interpreting data to calculate a precise error rate, for example by averaging.

According to an example embodiment of the present invention, the correction stages can advantageously be implemented sequentially at regular intervals.

Advantageously, a software platform can coordinate the reviews and aggregate the results of the individual reviewers or the individual AI models.

A software platform is a central application that organizes the checks and collects and aggregates the various check results.

This makes the review more efficient by centrally coordinating and analyzing the various results.

The errors can advantageously be stored in a database and used for further analysis.

A database is a storage system that stores the collected error data in a structured manner so that it can be used for future analysis and optimizations.

This allows error data to be used for later checks or to analyze error trends, which contributes to the continuous improvement of map quality.

According to an example embodiment of the present invention, the AI model can advantageously be optimized by machine learning, wherein the results of the individual correction stages are used as training data for the AI model in order to improve future calibration phases.

Machine learning is a process in which an AI model recognizes patterns by processing data, and, based on these patterns, continuously improves its performance. Training data are pieces of information that are provided to the model to increase the accuracy of its predictions and actions.

This ensures that the AI model operates more precisely as a result of the experience gained from the correction stages, which increases the efficiency and accuracy of future calibration phases.

According to an example embodiment of the present invention, the map sections for the calibration phase can advantageously be selected based on their complexity, in particular that map sections in a city center have a higher complexity than map sections in a forested area or parkland and are accordingly selected.

Complexity describes the degree of difficulty of the map elements, which results from the number and variety of features within a map section. Map sections in a city center typically contain more details, such as intersections, street names and POIs, while map sections in a forested area are less detailed.

This focuses the calibration phase on more challenging sections, which increases the effectiveness and accuracy of the entire process.

The results of the calibration phase can advantageously be displayed in a visual representation of the corrected digital map.

A visual representation is a graphical preparation of the corrected maps that shows the state of the map after the corrections have been implemented.

This allows users to understand the corrections that have been implemented and verify the quality of the corrections, which increases the transparency and usability of the process.

According to an example embodiment of the present invention, the digital map can advantageously include at least two different types of regions, wherein the calibration phase is carried out for two regions of different types, and the different numbers of needed correction stages ascertained during the calibration phase are applied to the respective types of regions of the digital map.

Regions refer to geographic or functional subdivisions of the digital map, for example urban areas, rural areas or industrial areas. Different types of regions have characteristic features that have to be taken into account during calibration.

This ensures that the correction is optimally tailored to the specific requirements of the respective regions, which increases the accuracy and efficiency of the method.

According to an example embodiment of the present invention, a prediction or a calculation of the remaining error rate or error probability can advantageously be ascertained after each correction stage to find out whether the predetermined value of the error rate has been achieved.

The error rate indicates how many errors remain in a map section, while the error probability is an estimate of the probability that errors will continue to occur.

This allows the correction stages to be specifically controlled and optimized, which avoids unnecessary correction stages and makes the process more efficient.

According to an example embodiment of the present invention, all map features and/or feature groups can advantageously be evaluated and corrected in a single correction procedure or the correction procedure, including the calibration phase, can be repeated separately for each individual map feature and/or feature group.

Map features are specific elements of a map, such as roads, buildings or bodies of water, whereas feature groups are an aggregation of similar map features.

This enables flexible adaptation of the correction procedure, which makes it possible to implement both global and targeted corrections and thus increases the adaptability of the method.

According to an example embodiment of the present invention, a prediction or a calculation of the remaining error rate or error probability can advantageously be ascertained after each correction stage to find out whether the predetermined value of the error rate of preferably no more than 5% has been achieved.

The prediction of the remaining error rate is based on the results of each correction stage and indicates how many errors there still are.

This allows early determination of whether the target error rate is being achieved, which avoids unnecessary further reviews.

According to an example embodiment of the present invention, AI models are used to implement the correction stages and

automatically detect errors in the digital map sections. AI models learn from the previous correction stages to more accurately identify future errors.

The use of multiple, individually trained AI models makes it possible to specifically identify different error classes in the digital maps. Each AI model is trained to a specific error category, such as positional errors, missing objects or incorrect attributions. This targeted specialization enables the models to independently reliably detect and correct different types of errors.

Compared to a single AI model trained to multiple error classes, this approach significantly improves the accuracy of error detection and correction. Thanks to its specialized structure, an individually trained AI model is particularly good at recognizing specific features of the respective error category. The independent models operate in parallel and complement one another, which enables more comprehensive and precise map verification.

A further subject matter of the present invention is a device for carrying out the above-described method for correcting a digital map, comprising a calibration unit, an evaluation unit and a correction unit. These components work together to efficiently analyze, calibrate, and correct map sections.

According to an example embodiment of the present invention, the calibration unit is a component of the device that carries out the calibration phase. During this phase, a first map section is selected and is subjected to a set number of correction stages. Correction stages are iterative steps that identify and correct errors in a map section.

According to an example embodiment of the present invention, the evaluation unit analyzes the results of the calibration phase, in particular the number of implemented correction stages in the first map section. Based on these results, the evaluation unit calculates the number of required correction stages for the remaining map sections.

According to an example embodiment of the present invention, the correction unit implements the ascertained correction stages in the remaining map sections. Remaining map sections are all of the portions of the digital map that were not corrected during the calibration phase.

One advantage of this device of the present invention is its ability to optimize the number of needed correction stages based on the results of the calibration phase. This makes the correction of the remaining map sections more efficient and resource-conserving.

### BRIEF DESCRIPTION OF THE DRAWINGS

The present invention is explained with reference to the figures.

FIG. 1 shows a schematic illustration of the method for correcting digital maps, according to an example embodiment of the present invention.

FIG. 2 shows a schematic illustration of the subdivision of a digital map into sections for calibration and periodic review, according to an example embodiment of the present invention.

FIG. 3 shows a graph showing the number of map errors found during the calibration phase of a randomly selected map feature, according to an example embodiment of the present invention.

FIG. 4 shows a schematic illustration of an embodiment of device for carrying out the method, according to an example embodiment of the present invention.

### DETAILED DESCRIPTION OF EXAMPLE EMBODIMENTS

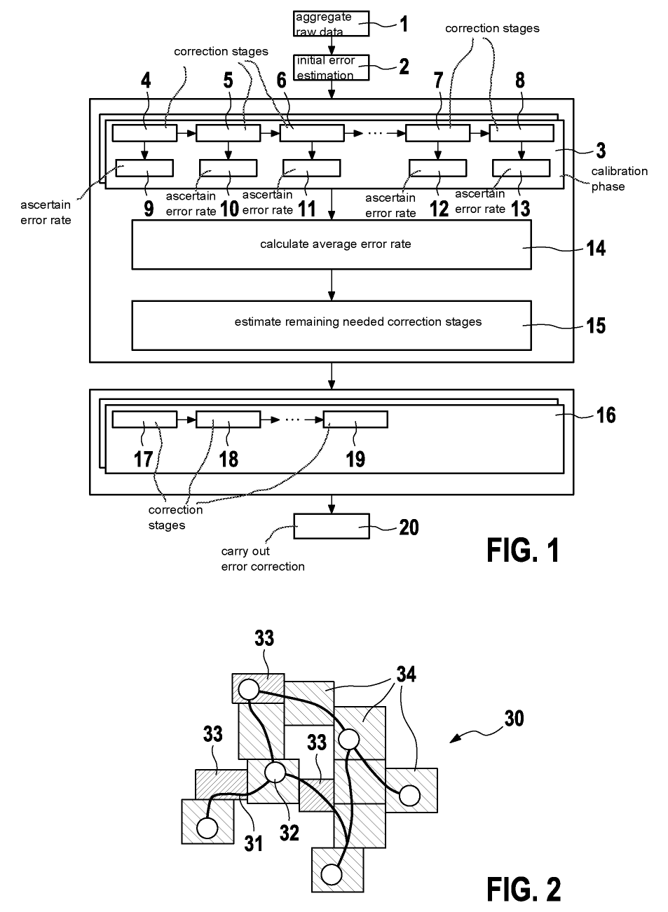

FIG. 1 illustrates the inventive method for correcting digital maps, in particular for individual map features or groups of map features. The method comprises multiple steps that systematically show the process of error checking and error reduction.

The first step is the creation of the map, during which the digital map is created. In this Step 1, raw data are aggregated to form a digital map section. This map contains geographic features that are relevant to the application; for example automated driving. This step is the foundation for all subsequent reviews and error corrections.

This is followed in a further Step 2 by the initial error estimation for each map feature, in which an initial error estimation is made for each map feature or group of map features. This initial estimation makes it possible to obtain an initial assessment of the error probability in the digital map. The error rate indicates how many errors are expected and serves as the basis for the further correction steps.

In the calibration phase 3 (calibration of the needed number of correction stages), the needed number of correction stages for a selected first map section of the map is calibrated. This involves the implementation of multiple reviews in a first correction stage 4, a second correction stage 5, a third correction stage 6, etc., up to a penultimate correction stage 7 and a final correction stage 8, wherein a separate error rate 9, 10, 11, 12, 13 is ascertained for each correction stage until no further errors 12, 13 are found in two successive correction stages 7, 8. This step ensures that the final number of correction stages is sufficient to achieve a set error rate. This phase determines how many correction stages are needed to minimize the error rate as much as possible.

After calibration, the further Step 14 involves using statistical methods to calculate an average error rate. This is followed by Step 15, in which the remaining needed correction stages are estimated and the number of correction stages needed for the remaining map sections of the digital map is ascertained. The number of correction stages for these remaining sections is reduced based on the calibration, so that said number is at least one stage, preferably three stages, less than in the first map section in order to minimize the verification burden without exceeding the set error rate.

In the next Step 16, the correction stages 17, 18, 19 are implemented with the required number ascertained for each one of the remaining map sections. Either manual reviewers or AI (artificial intelligence) models trained with training data can be used to examine the map for errors and achieve the set error rate.

Lastly, in Step 20, error correction is carried out, in which the detected errors are corrected either manually by the reviewer using a graphical user interface or automatically by another AI model.

FIG. 2 further illustrates the procedure for subdividing the digital map into sections for calibration and periodic review. This procedure enables efficient correction of the map by specifically dividing it into different map sections, that can be individually checked and calibrated.

First, the digital map 30 with roads 31 and intersections 32 is divided into multiple map sections, wherein each section represents a specific area of the map. This subdividing is carried out to selectively apply the calibration and review processes to individual sections of the map. The size and the layout of the map sections can vary depending on the application and geographic relevance.

In the first section, first map sections 33 are selected for calibration and used to calibrate the correction stages. These sections are checked during the calibration phase to determine the needed number of correction stages. The calibration sections 33 serve as representative portions of the entire map 30 and ensure that the error rate in these portions is reduced to such an extent that it can also be applied to the remaining second sections 34. The calibration ascertains how many correction stages are needed to achieve a set error rate, of preferably no more than 5%.

The remaining regular sections 34 of the map are checked after calibration, but with a reduced number of correction stages compared to the calibration sections. The number of correction stages in the regular sections 34 is ascertained based on the results of the calibration phase. This minimizes the number of correction stages for the regular sections in order to reduce the review effort while at the same time maintaining a set error rate.

FIG. 2 also shows that the map can not only be subdivided into sections spatially, but also in terms of the respective map content. These sections can be handled differently depending on the importance and geographic relevance of said sections. For instance, more important first sections 33, such as urban areas, can be checked in more detail than less important sections 34, such as rural or remote areas.

The map is divided into sections based on a variety of criteria, such as the geographic relevance of the sections, the usage frequency, or the safety relevance of the map sections.

During the calibration phase, the first sections 33 are therefore checked more intensively to determine how many correction stages are needed to achieve a set error rate; preferably no more than 5% of the remaining errors compared to the errors from the first correction stage.

The number of correction stages for the second sections 34 is typically set to be at least one stage, preferably three stages, less than the number of stages in the first calibration sections 33. This reduces the review effort without compromising the accuracy of the correction.

The distribution of the calibration follows a ratio of 5% to 95%: approximately 5% of the total map area, represented by the first calibration sections 33, is used for the intensive calibration, while the remaining 95% of the map, represented by the second regular sections 34, are validated with the reduced correction stages based on the calibration. This ensures efficient review of the entire map because the calibration results from the first sections are representative of the entire map. In summary, the procedure for subdividing the digital map into sections enables targeted and efficient calibration and periodic review of the map quality. The calibration sections serve as the basis for setting the correction stages that are then applied to the remaining regular sections. This optimizes the review effort without compromising the accuracy and reliability of the map.

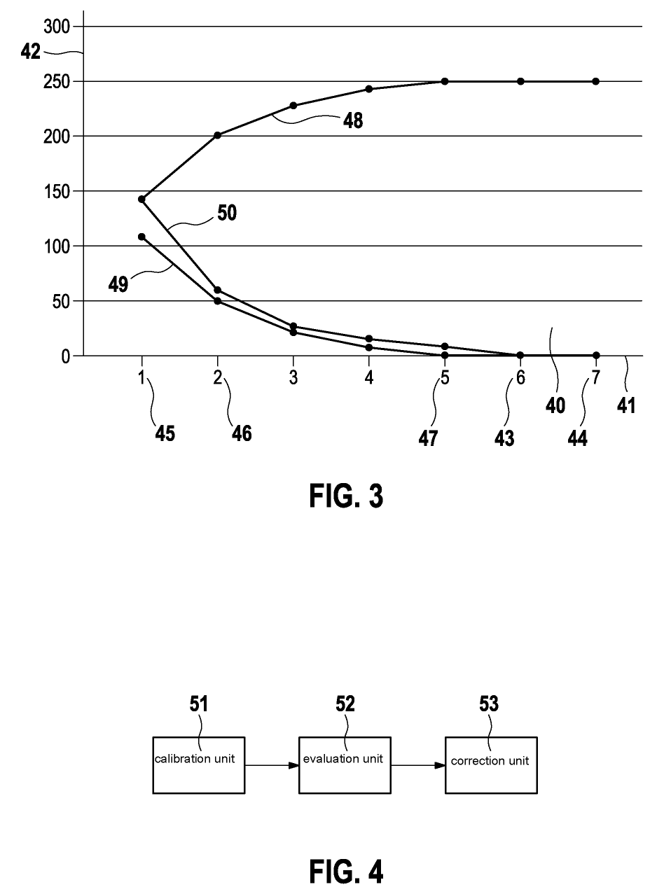

FIG. 3 shows a graph 40 that depicts the number of map errors found during the calibration phase of a randomly selected map feature. This graph illustrates how the number of errors decreases over the course of the calibration phase as the number of correction stages increases, and serves to optimize the calibration process for a specific map feature.

The number of correction stages is plotted on the x-axis 41 of the graph. Each correction stage represents a complete review process, in which the map feature is systematically checked for errors. As the number of correction stages increases, the number of remaining errors is expected to decrease until no further errors are found.

The y-axis 42 shows the number of map errors found. This includes all errors discovered in the respective correction stage. Typically, a larger number of errors are found at the beginning of the calibration phase because the map has not been thoroughly checked yet. With each further correction stage, the number of newly discovered errors decreases.

During the calibration phase, a randomly selected map feature is checked to determine how many correction stages are needed to achieve a set error rate. The graph shows that a relatively high number of errors are detected in the first correction stages. However, as the number of reviews increases, there is a steady decrease in the number of errors found.

The graph also illustrates that no further errors are found at the sixth correction stage 43 and the seventh correction stage 44, which correspond to the last two successive correction stages. This point marks the end of the calibration phase because the needed number of correction stages has been reached. From that point on, the results of the calibration can be applied to other map sections, which makes it possible to work there with a reduced number of reviews.

In the present case, therefore, FIG. 3 illustrates that approximately 140 errors are detected in a first correction stage 45 and approximately 50 errors are detected in the second correction stage 46. This shows that a relatively high number of errors are present at the beginning of the calibration phase because the map feature has not yet been sufficiently validated. The first review serves as a starting point for determining the total number of errors in the map feature.

After further correction stages, the number of errors decreases continuously. In the fifth correction stage 47, only 2 errors are found. This illustrates the success of the reviews, because the number of newly discovered errors has decreased significantly compared to the previous stages.

The first line 48 in the graph represents the sum of total number of errors found so far. It shows the cumulative number of errors detected in all of the correction stages together. This sum increases rapidly in the first correction stages because, at the beginning, a large number of errors are still being detected. From the fifth stage on, however, the line flattens out as only a few errors are found.

The second line 49 represents the remaining errors in the map that are still present after each correction stage. In the first stages, the number of remaining errors is high, because a lot of errors are discovered only gradually with each correction stage. With each further correction stage, the number of remaining errors decreases as can be seen from the decreasing slope of the second line. The third line 50 represents the errors found in each of the correction stages.

FIG. 4 shows a schematic illustration of an embodiment of a device for carrying out the method for correcting a digital map. The device consists of three functional units which are shown as rectangular boxes and are connected to one another by arrows to illustrate the flow of data between the units.

A calibration unit 51 is responsible for carrying out the calibration phase. In the calibration phase, a first map section of the digital map is selected and subjected to a set number of correction stages. The correction stages analyze the map section for errors, correct them, and ascertain the number of correction stages carried out. The output of the calibration unit provides the results of the calibration phase, in particular the ascertained number of correction stages, and forwards them to the evaluation unit.

An evaluation unit 52 processes the results of the calibration phase and uses them to calculate the number of correction stages needed for the remaining map sections. The evaluation unit 52 takes into account the deviations and error rates from the calibration phase and adjusts the number of correction stages accordingly. The calculated correction stages are forwarded to the correction unit as output data from the evaluation unit 52.

A correction unit 53 is responsible for checking and correcting the remaining map sections based on the number of correction stages calculated by the evaluation unit 52. The correction unit 53 analyzes the remaining map sections for errors and corrects them according to the specifications from the evaluation unit. The output of the correction unit leads to a fully corrected digital map.

What is claimed is:

1. The method for correcting a digital map comprising the following steps:
carrying out a calibration phase including the following steps:
selecting a first map section of the digital map,
checking the first map section for errors and correcting the errors found in the first map section in a first correction stage,
checking the corrected first map section for errors and correcting the errors found in the corrected first map section in a further correction stage,
repeating the further correction stage until fewer than a predetermined number of errors are found in at least two successive correction stages, as a result of which a first number of correction stages of the first map section from the calibration phase is ascertained;
ascertaining a second number of needed correction stages for remaining map sections of the digital map based on the first number of correction stages implemented in the calibration phase for the first map section, wherein the second number of needed correction stages is at least one correction stage less than the first number of correction stages implemented in the calibration phase; and
checking and correcting the remaining map sections of the digital map with the ascertained second number of correction stages.

2. The method according to claim 1, wherein the calibration phase is carried out separately for each type of map or specific map elements of the digital map in order to optimize a verification burden.

3. The method according to claim 1, wherein a correction stage of the first and further correction stages is implemented by a person or a manual reviewer, wherein the person compares the first map section with a reference map section with respect to at least one feature and manually corrects a deviation of the first map section from the reference map section in the first map section, using a graphical user interface.

4. The method according to claim 1, wherein a correction stage of the first and further correction stages is implemented automatically by an AI model, wherein the AI model checks the first map section with respect to at least one feature and corrects an error of the first map section in the first map section.

5. The method according to claim 3, wherein, in each of the first and further correction stages, multiple manual reviewers examine the first or correct first map sections of the map for errors using the graphical user interface or AI models to increase accuracy of the review, wherein an error rate is estimated by applying a statistical method to results of the different reviewers or AI models.

6. The method according to claim 4, wherein the AI model is optimized by machine learning, wherein results of the first and further correction stages are used as training data for the AI model in order to improve future calibration phases.

7. The method according to claim 1, wherein the errors found in the first and further correction stages are stored in a database and used for further analysis.

8. The method according to claim 1, wherein the first map section for the calibration phase is selected based on its complexity, wherein a map section in a city center having a higher complexity than map sections in a forested area or parkland, and the higher complexity map section is selected.

9. The method according to claim 1, wherein results of the calibration phase are displayed in a visual representation of a corrected digital map.

10. The method according to claim 1, wherein the digital map includes at least two different types of regions, wherein the calibration phase is carried out for two regions of different types, and different numbers of needed correction stages ascertained during the calibration phase are applied to the different types of regions of the digital map.

11. The method according to claim 1, wherein a prediction or a calculation of a remaining error rate or
error probability is ascertained after each of the first and further correction stages to find out whether a predetermined value of the error rate has been achieved.

12. The method according to claim 1, wherein all map features and/or feature groups are evaluated and corrected in a single correction procedure or the correction procedure, including the calibration phase, is repeated separately for each of the map features and/or feature groups.

13. A device, comprising:
a calibration unit configured to carrying out a calibration phase with a first number of correction stages in a selected first map section of a digital map;
an evaluation unit configured to calculate a second number of correction stages for remaining map sections of the digital map; and
a correction unit configured to correct the remaining map sections according to the ascertained second number of correction stages.

14. The device according to claim 13, wherein the device is configured to perform the following steps:
carrying out the calibration phase, the calibration phase including the following steps:
selecting the first map section of the digital map,
checking the first map section for errors and correcting the errors found in the first map section in a first correction stage,
checking the corrected first map section for errors and correcting the errors found in the corrected first map section in a further correction stage,
repeating the further correction stage until fewer than a predetermined number of errors are found in at least two successive correction stages, as a result of which the first number of correction stages of the first map section from the calibration phase is ascertained;
ascertaining the second number of correction stages for remaining map sections of the digital map based on the first number of correction stages implemented in the calibration phase for the first map section, wherein the second number of correction stages is at least one correction stage less than the first number of correction stages implemented in the calibration phase; and
checking and correcting the remaining map sections of the digital map with the ascertained second number of correction stages.
